(19) United States
(12) Patent Application Publication
(10) Pub. No.: US 2021/0316491 A1
(43) Pub. Date: Oct. 14, 2021

(54) METHOD FOR PRODUCING A MOLDING COMPOUND HAVING IMPROVED PROPERTIES

(71) Applicant: Covestro Intellectual Property GmbH & Co. KG, Leverkusen (DE)

(72) Inventors: Michael Erkelenz, Duisburg (DE); Reiner Rudolf, Langenfeld (DE); Hans-Juergen Thiem, Dormagen (DE)

(21) Appl. No.: 17/268,560

(22) PCT Filed: Aug. 15, 2019
(86) PCT No.: PCT/EP2019/071893

§ 371 Date: Feb. 15, 2021

(30) Foreign Application Priority Data
Sep. 4, 2018 (EP) 18192339.2

(51) Int. Cl. B29C 48/43; B29C 48/00; B29B 7/90

(52) U.S. Cl. CPC B29C 48/43; C08K 3/013; B29B 7/90; B29C 48/022

(57) ABSTRACT

The invention relates to a method for producing a molding compound having improved properties. In particular, the invention relates to the production of a molding compound containing a polycarbonate and a reinforcing filler. According to the invention, said molding compound can be obtained by compounding a polycarbonate and the reinforcing filler by means of multi-shaft extruder having screw shafts arranged annularly with respect to one another. The reinforcing filler is preferably selected from one or more members of the group comprising the members titanium dioxide (TiO₂), talc (Mg₃Si₄O₁₀(OH)₂), dolomite (CaMg[CO₃]₂). kaolinite (Al₄[(OH)₈|Si₄O₁₀]) and wollastonitc (Ca₃[Si₃O₉]), preferably from one or more members of the group comprising the members titanium dioxide (TiO₂) and talc (Mg₃Si₄O₁₀(OH)₂). According to the invention, tlie concentration of reinforcing filler is 3 to 50 wt % in relation to the total mass of tlie molding compound.

The present invention relates to a process for producing a molding material having improved properties. The present invention especially relates to the production of a molding material containing a polycarbonate and a reinforcing filler.

According to the invention this molding material is obtainable by compounding a polycarbonate and the reinforcing filler using a multi-screw extruder having screw shafts arranged annularly relative to one another.

The reinforcing filler is preferably selected from one or more members of the group comprising the members titanium dioxide (TiO₂), talc (Mg₃Si₄O₁₀(OH)₂), dolomite (CaMg[CO₃]₂), kaolinite (Al₄[(OH)₈,|Si₄O₁₀]) and wollastonite (Ca₃[Si₃O₉]), particularly preferably selected from one or more members of the group comprising the members titanium dioxide (TiO₂) and talc (Mg₃Si₄O₁₀(OH)₂).

According to the invention the content of reinforcing filler is 3% to 50% by weight, in each case based on the total mass of the molding material.

It is preferable when the content of reinforcing filler is 10% to 35% by weight, particularly preferably 12% to 32% by weight, very particularly preferably 15% to 30% by weight, in each case based on the total mass of the molding material. These values especially apply to titanium dioxide (TiO₂) as reinforcing filler but also apply to other reinforcing fillers such as talc (Mg₃Si₄O₁₀(OH)₂), dolomite CaMg[CO₃]₂, kaolinite Al₄[(OH)₈|Si₄O₁₀] and wollastonite Ca₃[Si₃O₉].

It is alternatively preferable when the content of reinforcing filler is 15% to 45% by weight, particularly preferably 25% to 40% by weight, very particularly preferably 30% to 35% by weight, in each case based on the total mass of the molding material. These values especially apply to talc (Mg₃Si₄O₁₀(OH)₂) as reinforcing filler but also apply to other reinforcing fillers such as titanium dioxide (TiO₂), dolomite (CaMg[CO₃]₂), kaolinite (Al₄[(OH)₈|Si₄O₁₀]) and wollastonite (Ca₃[Si₃O₉]).

The process according to the invention especially comprises the steps of:

(1) adding polycarbonate, reinforcing filler and optionally other constituents to a multi-screw extruder having screw shafts arranged annularly relative to one another;

(2) compounding polycarbonate and reinforcing filler and optionally other constituents with a multi-screw extruder having screw shafts arranged annularly relative to one another.

Polycarbonate, reinforcing filler and optionally other constituents may be simultaneously or successively added to the multi-screw extruder having screw shafts arranged annularly relative to one another. The addition of the reinforcing filler may in particular be carried out either before the melting of the polycarbonate or after the melting of the polycarbonate.

According to the content of reinforcing filler the content of polycarbonate in the molding material according to the invention is 97% to 55% by weight, in each case based on the total mass of the molding material.

It is preferable when the content of polycarbonate in the molding material according to the invention is 90% to 65% by weight, particularly preferably 88% to 68% by weight, very particularly preferably 85% to 70% by weight, in each case based on the total mass of the molding material.

It is alternatively preferable when the content of reinforcing filler is 15% to 45% by weight, particularly preferably 25% to 40% by weight, very particularly preferably 30% to 35% by weight.

It is alternatively preferable when the content of polycarbonate in the molding material according to the invention is 85% to 55% by weight, particularly preferably 75% to 60% by weight, very particularly preferably 70% to 65% by weight, in each case based on the total mass of the molding material.

The molding material may also contain other constituents. The content of the other constituents in the molding material containing a polycarbonate and a reinforcing filler is from 0% to 37% by weight, preferably from 0% to 20% by weight, particularly preferably from 0% to 10% by weight, in each case based on the total mass of the molding material. The sum of all constituents of the molding material is 100% by weight.

A molding material containing a polycarbonate is hereinbelow also referred to as a polycarbonate molding material.

It is known from the prior art, for example from [1] ([1]=Klemens Kohlgrüber: Der gleichläufige Doppelschneckenextruder [Co-rotating twin-screw extruders], 2nd revised and expanded edition, Hanser Verlag Munich 2016, p. 47ff), to prepare polymer molding materials, such as for example a molding material containing a polycarbonate of one of these polymer molding materials, by admixing additives, for example fillers, in such a way that these polymer molding materials achieve a desired profile of properties. This preparation, also known as compounding, is generally performed in a twin-screw extruder. It is especially desirable to achieve a best possible dispersion of the fillers in the polymer molding material, i.e. a best possible comminution and distribution of the fillers in the polymer molding material. The compounding becomes ever more difficult the higher the content of the fillers to be dispersed in the polymer molding material and the better the dispersion, i.e. the better the comminution and distribution, of the fillers in the polymer molding material is to be.

Improved dispersion of fillers in a polymer molding material has the effect inter alia that the molding material has improved properties, in particular improved surface properties and improved mechanical properties such as for example higher toughness, higher force absorption and greater elongation in the puncture test.

In order to achieve improved dispersion with a highest possible content of fillers for a given twin-screw extruder, the energy input into the polymer molding material must be increased. However this has the result that the temperature of the polymer molding material in the twin-screw extruder increases during the compounding, the more so the higher the energy input. This in turn means that the polymer molding material can suffer thermal damage. This may in turn result in yellowing of the polymer molding material or in formation of specks or other undesired changes to the polymer molding material.

Since this thermal damage is generally to be avoided, better dispersion is foregone or the content of filler is not increased or both. However, in rare cases, thermal damage or poor dispersion, or both, are tolerated. However, this mode does not make it possible to obtain polymer molding materials having improved properties. In particular, this mode does not make it possible to simultaneously improve the surface properties and the mechanical properties of the polymer molding material.

It has also been found that the use of a twin-screw extruder having a larger length-to-diameter ratio (L/D ratio) than in the case of the twin-screw extruder specified at the outset does not remedy the problem, since even for a twin-screw extruder having a larger L/D ratio the thermal stress on the polymer molding material becomes undesirably high if the desired improved dispersion is to be achieved at a desired high content of fillers because increasing the L/D ratio of a twin-screw extruder at otherwise unchanged conditions causes the temperature of the extruded polymer molding material to increase by about 10° C. to 20° C. per additional length of the twin-screw extruder corresponding to four times the external diameter of a screw element that cleans the inner wall of the twin-screw extruder. This mode, therefore, does not make it possible to obtain polymer molding materials having improved properties either. In particular, this mode does not make it possible to simultaneously improve the surface properties and the mechanical properties of the polymer molding material.

The described problem is also encountered when a polycarbonate molding material having a high proportion of a reinforcing filler is to be produced by compounding.

The present invention therefore has for its object to provide a process for producing improved polycarbonate molding material containing a reinforcing filler.

The polycarbonate molding material according to the invention shall especially have the following improved properties:
(1) improved surface properties, especially fewer imperfections, especially in turn fewer imperfections in the form of elevations or depressions in the surface brought about by incompletely dispersed reinforcing filler particles;
(2) and improved mechanical properties, in particular higher toughness, higher force absorption, greater elongation and greater deformation, especially greater toughness.

It has surprisingly been found that the object is achieved by a process for producing a molding material containing a polycarbonate and a reinforcing filler, preferably selected from one or more members of the group comprising the members titanium dioxide (TiO₂) talc (Mg₃Si₄O₁₀(OH)₂), dolomite CaMg[CO₃]₂, kaolinite Al₄[(OH)₈|Si₄O₁₀] and wollastonite Ca₃[Si₃O₉], preferably selected from one or more members of the group comprising the members titanium dioxide (TiO₂) and talc (Mg₃Si₄O₁₀(OH)₂), wherein the polycarbonate molding material is compounded using a multi-screw extruder having screw shafts arranged annularly relative to one another. The content of reinforcing filler is 3% to 45% by weight, in each case based on the total mass of the polycarbonate molding material.

It is preferable when the content of reinforcing filler is 10% to 35% by weight, particularly preferably 12% to 32% by weight, very particularly preferably 15% to 30% by weight, in each case based on the total mass of the molding material. These values especially apply to titanium dioxide (TiO₂) as reinforcing filler but also apply to other reinforcing fillers such as talc (Mg₃Si₄O₁₀(OH)₂), dolomite (CaMg[CO₃]₂), kaolinite (Al₄[(OH)₈|Si₄O₁₀]) and wollastonite (Ca₃[Si₃O₉]).

It is alternatively preferable when the content of reinforcing filler is 15% to 45% by weight, particularly preferably 25% to 40% by weight, very particularly preferably 30% to 35% by weight, in each case based on the total mass of the molding material. These values especially apply to talc (Mg₃Si₄O₁₀(OH)₂) as reinforcing filler but also apply to other reinforcing fillers such as titanium dioxide (TiO₂), dolomite (CaMg[CO₃]₂), kaolinite (Al₄[(OH)₈|Si₄O₁₀]) and wollastonite (Ca₃[Si₃O₉]).

In the context of the present invention a reinforcing filler is to be understood as meaning a mineral filler suitable for increasing the stiffness of the polycarbonate molding material produced according to the invention.

In particular, the process according to the invention affords polycarbonate molding materials having the following improved properties:
(1) improved surface properties, especially fewer imperfections, especially in turn fewer imperfections in the form of elevations or depressions in the surface brought about by incompletely dispersed reinforcing filler particles. Incompletely dispersed reinforcing filler particles may be determined for example by a visual analysis of images of molded articles produced from the molding material according to the invention; the particle size distribution of the incompletely dispersed reinforcing filler particles may be assessed by means of a classification;
(2) and improved mechanical properties, in particular higher toughness, higher force absorption, greater elongation and greater deformation, especially greater toughness. These mechanical properties may be determined for example with a puncture measurement according to DIN EN ISO 6603-2:2000 at 23° C. on an injection molded test specimen having dimensions of 60 mm×60 mm×2.0 mm; the mathematical product of maximum force and maximum deformation as a measure of mechanical toughness is particularly informative here and a higher value of this product denotes a higher toughness.

Such a polycarbonate molding material produced according to the invention exhibits better, i.e. improved, properties compared to polycarbonate molding materials produced by processes according to the prior art, wherein the polycarbonate molding materials produced according to the prior art contain the same constituents in the same proportions as the polycarbonate molding material produced according to the invention.

In the context of the present invention the term “molded article” is to be understood as meaning an article which is the result of further processing of the molding material. Thus for example not only articles obtainable from the molding material by injection molding but also films or sheets obtainable by extrusion of the molding material are to be considered as molded articles.

The titanium dioxide (TiO₂) employed is preferably the rutile modification having a particle size d₅₀ of 0.1 μm to 5 μm, preferably 0.3 to 3 μm. Examples of titanium dioxide usable according to the invention are selected from the commercially available products Kronos 2230 titanium dioxide and Kronos 2233 titanium dioxide; both products are from the manufacturer Kronos Titan GmbH Leverkusen.

Talc (Mg₃Si₄O₁₀(OH)₂) is preferably employed with a particle size d₅₀ of 0.1 m to 10 μm, preferably 0.3 to 3 μm. Employable tales include for example the commercially available products Jetfine 3CA from Imerys Talc (Luzenac Europe SAS) or HTP Ultra 5C talc from IMI Fabi S.p.A.

Particle size d₅₀ is in each case based on mass and was determined according to ISO 1333 17-3 using a Sedigraph 5100 from Micrometrics, Germany.

Mixtures of titanium dioxide and talc may be employed in any desired mixture ratios. It is preferable when the mixing ratio of titanium dioxide to talc is 1:60 to 1:1, preferably 1:30 to 1:5, in each case based on the mass.

The particles of the respective mineral of which the reinforcing filler consists preferably have an aspect ratio of 1:1 to 1:7.

In the context of the present invention “polycarbonate” is to be understood as meaning both homopolycarbonates and copolycarbonates. The polycarbonates may be linear or branched in the familiar manner. Also employable according to the invention are mixtures of polycarbonates.

A portion, up to 80 mol %, preferably from 20 mol % up to 50 mol %, of the carbonate groups in the polycarbonates used in accordance with the invention may have been replaced by preferably aromatic dicarboxylic ester groups. Polycarbonates of this kind that incorporate both acid radicals from the carbonic acid and acid radicals from preferably aromatic dicarboxylic acids into the molecular chain are referred to as aromatic polyestercarbonates.

Replacement of the carbonate groups by the aromatic dicarboxylic ester groups is in essence stoichiometric, and also quantitative, and the molar ratio of the reactants is therefore also maintained in the final polyestercarbonate. The aromatic dicarboxylic ester groups can be incorporated either randomly or blockwise.

The thermoplastic polycarbonates including the thermoplastic polyestercarbonates have average molecular weights Mw determined by GPC (gel permeation chromatography in methylene chloride with a polycarbonate standard) of 15 kg/mol to 50 kg/mol, preferably of 20 kg/mol to 35 kg/mol, more preferably of 23 kg/mol to 33 kg/mol.

The preferred aromatic polycarbonates and/or aromatic polyestercarbonates are produced in a known manner from diphenols, carbonic acid or carbonic acid derivatives and, in the case of the polyestercarbonates, preferably aromatic dicarboxylic acids or dicarboxylic acid derivatives, optionally chain terminators and branching agents.

Particulars pertaining to the production of polycarbonates are disclosed in many patent documents spanning approximately the last 40 years. Reference may be made here for example to Schnell, “Chemistry and Physics of Polycarbonates”, Polymer Reviews, Volume 9, Interscience Publishers, New York, London, Sydney 1964, and to D. Freitag, U. Grigo, P. R. Müller, H. Nouvertnd, BAYER AG, “Polycarbonates” in Encyclopedia of Polymer Science and Engineering, Volume 11, Second Edition, 1988, pages 648-718, and finally to U. Grigo, K. Kirchner and P. R. Müller “Polycarbonate” in Becker/Braun, Kunststoff-Handbuch [Plastics handbook], vol. 3/1, Polycarbonate, Polyacetale, Polyester, Celluloseester [Polycarbonates, polyacetals, polyesters, cellulose esters], Carl Hanser Verlag Munich, Vienna 1992, pages 117-299.

Production of aromatic polycarbonates and polyestercarbonates is carried out for example by reaction of diphenols with carbonic halides, preferably phosgene, and/or with aromatic dicarboxyl dihalides, preferably benzenedicarboxyl dihalides, by the interfacial process, optionally using chain terminators and optionally using trifunctional or more than trifunctional branching agents, production of the polyestercarbonates being achieved by replacing a portion of the carbonic acid derivatives with aromatic dicarboxylic acids or derivatives of the dicarboxylic acids, specifically with aromatic dicarboxylic ester structural units according to the proportion of carbonate structural units to be replaced in the aromatic polycarbonates. Production via a melt polymerization process by reaction of diphenols with for example diphenyl carbonate is likewise possible.

Dihydroxyaryl compounds suitable for producing polycarbonates are those of formula (1)

HO—Z—OH (1),

in which

Z is an aromatic radical which has 6 to 30 carbon atoms and may comprise one or more aromatic rings, may be substituted and may comprise aliphatic or cycloaliphatic radicals or alkylaryls or heteroatoms as bridging elements.

It is preferable when Z in formula (1) represents a radical of formula (2)

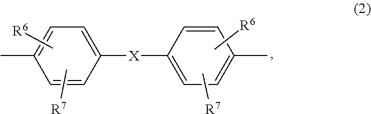

in which

R6 and R7 independently of one another represent H, C1- to C18-alkyl, C1- to C18-alkoxy, halogen such as Cl or Br or in each case optionally substituted aryl or aralkyl, preferably H or C1-to C12-alkyl, particularly preferably H or C1- to C8-alkyl and very particularly preferably H or methyl, and X represents a single bond, —SO2-, —CO—, —O—, —S—, C1- to C6-alkylene, C2- to C5-alkylidene or C5- to C6-cycloalkylidene which may be substituted by C1- to C6-alkyl, preferably methyl or ethyl, or else represents C6- to C12-arylene which may optionally be fused to further aromatic rings containing heteroatoms.

It is preferable when X represents a single bond, C1- to C5-alkylene, C2- to C5-alkylidene, C5- to C6-cycloalkylidene, —O—, —SO—, —CO—, —S—, —SO2-

or a radical of the formula (2a)

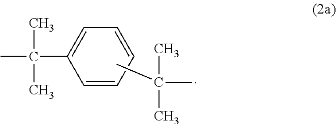

Diphenols suitable for the production of polycarbonates are for example hydroquinone, resorcinol, dihydroxydiphenyls, bis(hydroxyphenyl)alkanes, bis(hydroxyphenyl)cycloalkanes, bis(hydroxyphenyl)sulfides, bis(hydroxyphenyl)ethers, bis(hydroxyphenyl)ketones, bis(hydroxyphenyl)sulfones, bis(hydroxyphenyl)sulfoxides, α,α′-bis(hydroxyphenyl)diisopropylbenzenes, phthalimidines derived from derivatives of isatin or phenolphthalein and the ring-alkylated, ring-arylated and ring-halogenated compounds thereof.

Preferred diphenols are 4,4′-dihydroxybiphenyl, 2,2-bis(4-hydroxyphenyl)propane (bisphenol A), 2,4-bis(4-hydroxyphenyl)-2-methylbutane, 1,1-bis(4-hydroxyphenyl)-p-diisopropylbenzene, 2,2-bis(3-methyl-4-hydroxyphenyl)propane, dimethylbisphenol A, bis(3,5-dimethyl-4-hydroxyphenyl)methane, 2,2-bis(3,5-dimethyl-4-hydroxyphenyl)propane, bis(3,5-dimethyl-4-hydroxyphenyl)sulphone, 2,4-bis(3,5-dimethyl-4-hydroxyphenyl)-2-methylbutane, 1,1-bis(3,5-dimethyl-4-hydroxyphenyl)-p-diisopropylbenzene and 1,1-bis(4-hydroxyphenyl)-3,3,5-trimethylcyclohexane.

Particularly preferred diphenols are 2,2-bis(4-hydroxyphenyl)propane (bisphenol A), 2,2-bis(3,5-dimethyl-4-hydroxyphenyl)propane, 1,1-bis(4-hydroxyphenyl)cyclohexane, 1,1-bis(4-hydroxyphenyl)-3,3,5-trimethylcyclohexane and dimethylbisphenol A.

Greatest preference is given to 2,2-bis(4-hydroxyphenyl)propane (bisphenol A).

These and other suitable diphenols are described for example in U.S. Pat. Nos. 3,028,635, 2,999,825, 3,148,172, 2,991,273, 3,271,367, 4,982,014 and 2,999,846, in DE-A 1 570 703, DE-A 2 063 050, DE-A 2 036 052, DE-A 2 211 956 and DE-A 3 832 396, in FR-A 1 561 518, in the monograph “H. Schnell, Chemistry and Physics of Polycarbonates, Interscience Publishers, New York 1964” and also in JP-A 62039/1986, JP-A 62040/1986 and JP A 105550/1986.

In the case of homopolycarbonates, only one diphenol is employed, and in the case of copolycarbonates, two or more diphenols are employed. The diphenols employed, similarly to all other chemicals and assistants added to the synthesis, may be contaminated with the contaminants from their own synthesis, handling and storage. However, it is desirable to use raw materials of the highest possible purity.

Examples of suitable carbonic acid derivatives are phosgene and diphenyl carbonate.

Suitable chain terminators that may be employed in the production of polycarbonates are monophenols. Suitable monophenols are for example phenol itself, alkylphenols such as cresols, p-tert-butylphenol, cumylphenol and mixtures thereof.

Preferred chain terminators are phenols which are mono- or polysubstituted with linear or branched, preferably unsubstituted C1 to C30 alkyl radicals or with tert-butyl. Particularly preferred chain terminators are phenol, cumylphenol and/or p-tert-butylphenol.

The amount of chain terminator to be employed is preferably 0.1 to 5 mol % based on moles of diphenols employed in each case. The addition of the chain terminators may be carried out before, during or after the reaction with a carbonic acid derivative.

Suitable branching agents are the trifunctional or more than trifunctional compounds known in polycarbonate chemistry, in particular those having three or more than three phenolic OH groups.

Suitable branching agents are for example 1,3,5-tri(4-hydroxyphenyl)benzene, 1,1,1-tri(4-hydroxyphenyl)ethane, tri(4-hydroxyphenyl)phenylmethane, 2,4-bis(4-hydroxyphenylisopropyl)phenol, 2,6-bis(2-hydroxy-5′-methylbenzyl)-4-methylphenol, 2-(4-hydroxyphenyl)-2-(2,4-dihydroxyphenyl)propane, tetra(4-hydroxyphenyl)methane, tetra(4-(4-hydroxyphenylisopropyl)phenoxy)methane and 1,4-bis((4′,4″-dihydroxytriphenyl)methyl)benzene and 3,3-bis(3-methyl-4-hydroxyphenyl)-2-oxo-2,3-dihydroindole.

The amount of the branching agents for optional use is preferably 0.05 mol % to 2.00 mol % based on moles of diphenols used in each case.

The branching agents can either be initially charged with the diphenols and the chain terminators in the aqueous alkaline phase or added dissolved in an organic solvent before the phosgenation. In the case of the transesterification process the branching agents are employed together with the diphenols.

Particularly preferred polycarbonates are the homopolycarbonate based on bisphenol A, the homopolycarbonate based on 1,3-bis(4-hydroxyphenyl)-3,3,5-trimethylcyclohexane and the copolycarbonates based on the two monomers bisphenol A and 1,1-bis(4-hydroxyphenyl)-3,3,5-trimethylcyclohexane.

Preferred modes of production of the polycarbonates to be used according to the invention, including the polyestercarbonates, are the known interfacial process and the known melt transesterification process (cf. e.g. WO 2004/063249 A1, WO 2001/05866 A1, WO 2000/105867, U.S. Pat. Nos. 5,340,905 A, 5,097,002 A, 5,717,057 A).

Most preferably employed as the polycarbonate is aromatic polycarbonate based on bisphenol A.

It is possible to add to the polycarbonate molding material according to the invention not only titanium dioxide (TiO₂) and/or talc (Mg₃Si₄O₁₀(OH)₂), dolomite (CaMg[CO₃]₂), kaolinite (Al₄[(OH)₈|Si₄O₁₀]) and/or wollastonite (Ca₃[Si₃O₉]) but also other constituents.

The content of the other constituents in the polycarbonate molding material produced according to the invention is from 0% to 37% by weight, preferably from 0% to 20% by weight, particularly preferably 0% to 10% by weight.

These other constituents are constituents which are neither polycarbonate nor reinforcing filler. These other constituents are in particular constituents which are neither polycarbonate nor titanium dioxide (TiO₂), talc (Mg₃Si₄O₁₀(OH)₂), dolomite (CaMg[CO₃]₂), kaolinite (Al₄[(OH)₈|Si₄O₁₀]) or wollastonite (Ca₃[Si₃O₉]).

For example other fillers customary for polycarbonate molding materials, other thermoplastics, for example acrylonitrile-butadiene-styrene copolymers, or other additives such as UV stabilizers, IR stabilizers, heat stabilizers, antistats, dyes and pigments may be added in the usual amounts; it is optionally possible to improve demolding characteristics, flow characteristics and/or flame retardancy by adding external mold release agents, flow agents and/or flame retardants (for example alkyl and aryl phosphites, phosphates, phosphanes, low molecular weight carboxylic acid esters, halogen compounds, salts, chalk, quartz flour, glass and carbon fibers, pigments and combinations thereof. Such compounds are described for example in WO 99/55772, p. 15-25, and in “Plastics Additives”, R. Gachter and H. MGller, Hanser Publishers 1983.

Suitable additives are described for example in “Additives for Plastics Handbook, John Murphy, Elsevier, Oxford 1999”, in “Plastics Additives Handbook, Hans Zweifel, Hanser, Munich 2001”.

Suitable antioxidants/thermal stabilizers are for example:

alkylated monophenols, alkylthiomethylphenols, hydroquinones and alkylated hydroquinones, tocopherols, hydroxylated thiodiphenyl ethers, alkylidenebisphenols, O-, N- and S-benzyl compounds, hydroxybenzylated malonates, aromatic hydroxybenzyl compounds, triazine compounds, acylaminophenols, esters of ß-(3,5-di-tert-butyl-4-hydroxyphenyl)propionic acid, esters of ß-(5-tert-butyl-4-hydroxy-3-methylphenyl)propionic acid, esters of ß-(3,5-dicyclohexyl-4-hydroxyphenyl)propionic acid, esters of 3,5-di-tert-butyl-4-hydroxyphenylacetic acid, amides of ß-(3,5-di-tert-butyl-4-hydroxyphenyl)propionic acid, suitable thio synergists, secondary antioxidants, phosphites and phosphonites, benzofuranones and indolinones.

Preference is given to organic phosphites, phosphonates and phosphanes, mostly those in which the organic radicals consist completely or partially of optionally substituted aromatic radicals.

Suitable complexing agents for heavy metals and neutralization of traces of alkalis are o/m-phosphoric acids, fully or partly esterified phosphates or phosphites.

Suitable light stabilizers (UV absorbers) are 2-(2′-hydroxyphenyl)benzotriazoles, 2-hydroxybenzophenones, esters of substituted and unsubstituted benzoic acids, acrylates, sterically hindered amines, oxamides and 2-(hydroxyphenyl)-1,3,5-triazines/substituted hydroxyalkoxyphenyl, 1,3,5-triazoles, preference being given to substituted benzotriazoles, for example 2-(2′-hydroxy-5′-methyl-phenyl)benzotriazole, 2-(2′-hydroxy-3′,5′-di-t-butylphenyl)benzotriazole, 2-(2′-hydroxy-3′-tert.-butyl-5′-methylphenyl)-5-chlorobenzotriazole, 2-(2′-hydroxy-3′,5′-tert.-butylphenyl)-5-chloro-benzotriazole, 2-(2′-hydroxy-5′-tert.-octylphenyl)benzotriazole, 2-(2′-hydroxy-3′,5′-di-tert.-amylphenyl)benzotriazole, 2-[2′-hydroxy-3′-(3″,4″,5″,6″-tetrahydrophthalimidoethyl)-5′-methylphenyl]-benzotriazole and 2,2′-methylenebis[4-(1,1,3,3-tetramethylbutyl)-6-(2H-benzotriazol-2-yl)phenol].

Polypropylene glycols, alone or in combination with, for example, sulfones or sulfonamides as stabilizers, can be used to counteract damage by gamma rays.

These and other stabilizers can be used individually or in combination and can be added to the polycarbonate in the recited forms.

It is also possible to add processing aids such as mold release agents, mostly derivatives of long-chain fatty acids. Pentaerythritol tetrastearate and glycerol monostearate for example are preferred. Said mold release agents are employed on their own or as mixtures.

Suitable flame retardant additives are phosphate esters, i.e. triphenyl phosphate, resorcinol diphosphate, brominated compounds, such as brominated phosphoric esters, brominated oligocarbonates and polycarbonates, and preferably salts of fluorinated organic sulfonic acids.

Suitable impact modifiers are butadiene rubber with grafted-on styrene-acrylonitrile or methyl methacrylate, ethylene-propylene rubbers with grafted-on maleic anhydride, ethyl and butyl acrylate rubbers with grafted-on methyl methacrylate or styrene-acrylonitrile, interpenetrating siloxane and acrylate networks with grafted-on methyl methacrylate or styrene-acrylonitrile.

It is further possible to add colorants, such as organic dyes or pigments or inorganic pigments, IR absorbers, individually, as mixtures or else in combination with stabilizers, glass fibers, (hollow) glass spheres, inorganic, in particular mineral, fillers.

The polycarbonate molding material according to the invention, optionally in admixture with other thermoplastics and/or customary additives, may be employed anywhere where prior art polycarbonate molding materials are employed.

A multi-screw extruder having screw shafts arranged annularly relative to one another has 8 to 16, usually 10 or 12, co-rotating screw shafts. The screw shafts are fitted with screw elements which in each case preferably mesh tightly with the respective immediately adjacent screw elements of the respectively immediately adjacent screw shafts. The screw shafts are arranged annularly around an inner core having a contour adapted to the screw shafts fitted with the screw elements. Each screw shaft is immediately adjacent to two other screw shafts. These screw shafts are outwardly encompassed by an outer housing whose inner contour is likewise adapted to the screw shafts. The housing and/or the core of the multi-screw extruder having screw shafts arranged annularly relative to one another may be both heatable and coolable.

In the context of the present invention such a multi-screw extruder having screw shafts arranged annularly relative to one another is hereinbelow also referred to as a ring extruder.

The screw elements of a ring extruder do not differ from those of a twin-screw extruder addressing the same process engineering objective. The process zones of a ring extruder also also do not differ from those of a twin-screw extruder addressing the same process engineering objective.

The external diameter of a tightly meshing screw element is also referred to as DA. The core radius of such a screw element is referred to as DI.

In the context of the present invention the L/D ratio is the quotient of the length of the section of the screw shaft fitted with screw elements and the external diameter of a tightly meshing screw element that cleans the inner wall of the extruder.

Ring extruders in and of themselves are known for example from: DE4412725A1, DE4412741A1, DE19622582A1, DE202007004997U1, DE202007005010U1, WO03020493A1 and WO2006045412A2 and also from the publication “Compoundieren mit zwölf Wellen” [“compounding with twelve shafts” ] Carl Hanser Verlag, Munich, KU Kunststoffe, volume 90 (2000) 8, pages 60 to 62.

It is also known that ring extruders improve product quality and achieve good dispersion performance.

However, the prior art nowhere discloses that a ring extruder makes it possible to produce a polycarbonate molding material containing a reinforcing filler and having improved properties. In particular, the prior art nowhere discloses a process for producing a polycarbonate molding material containing a reinforcing filler, preferably selected from one or more members of the group comprising the members titanium dioxide (TiO₂), talc (Mg₃Si₄O₁₀(OH)₂), dolomite (CaMg[CO₃]₂), kaolinite (Al₄[(OH)₈|Si₄O₁₀]) and wollastonite (Ca₃[Si₃O₉]), preferably selected from one or more members of the group comprising the members titanium dioxide (TiO₂) and talc (Mg₃Si₄O₁₀(OH)₂), wherein the content of reinforcing filler is 3% to 45% by weight, in each case based on the total mass of the polycarbonate molding material.

It is preferable when the content of reinforcing filler is 10% to 35% by weight, particularly preferably 12% to 32% by weight, very particularly preferably 15% to 30% by weight, in each case based on the total mass of the molding material. These values especially apply to titanium dioxide (TiO₂) as reinforcing filler but also apply to other reinforcing fillers such as talc (Mg₃Si₄O₁₀(OH)₂), dolomite (CaMg[CO₃]₂), kaolinite (Al₄[(OH)₈|Si₄O₁₀]) and wollastonite (Ca₃[Si₃O₉]).

It is alternatively preferable when the content of reinforcing filler is 15% to 45% by weight, particularly preferably 25% to 40% by weight, very particularly preferably 30% to 35% by weight, in each case based on the total mass of the molding material. These values especially apply to talc (Mg₃Si₄O₁₀(OH)₂) as reinforcing filler but also apply to other reinforcing fillers such as titanium dioxide (TiO₂), dolomite (CaMg[CO₃]₂), kaolinite (Al₄[(OH)₈|Si₄O₁₀]) and wollastonite (Ca₃[Si₃O₉]).

Such a polycarbonate molding material produced according to the invention exhibits better properties than polycarbonate molding materials produced by processes according to the prior art, wherein the polycarbonate molding materials produced according to the prior art contain the same constituents in the same proportions as the polycarbonate molding material produced according to the invention.

According to the invention it is preferable to use a ring extruder having 10 or 12 screw shafts, particularly preferably a ring extruder having 12 screw shafts.

It is further preferable according to the invention when the ring extruder has an L/D ratio of 28 to 45, particularly preferably of 33 to 42.

It is further preferable according to the invention when the ring extruder has a DA/DI ratio of 1.5 to 1.8, particularly preferably of 1.55 to 1.74.

It is further preferable according to the invention when the ring extruder has a torque density of 2 to 10 Nm/cm³, preferably of 4 to 8 Nm/cm³, particularly preferably of 5.5 to 6.5 Nm/cm³, wherein the torque density is defined as the quotient of the maximum torque of a screw shaft divided by the third power of the axis distance between two adjacent screw shafts.

It is further preferable according to the invention when the screw elements of the ring extruder have an external diameter DA of 10 to 100 mm.

It is further preferable according to the invention when the ring extruder has a flight depth defined as (DA−DI)/2 of 2 to 40 mm.

It is further preferable according to the invention when the ring extruder has a free cross-sectional area of 5 to 1000 cm². The free cross-sectional area is the area of the extruder bore that is not occupied by screw elements or the extruder shaft, i.e. which is available for conveying the polycarbonate molding material.

The ring extruder employed according to the invention may be for example any of the ring extruders having the designations RingExtruder RE® 3 XP, RingExtruder RE® 1 XPV or RingExtruder RE® 3 XPV from Extricom Extrusion GmbH.

The present invention further provides a molding material produced by the process according to the invention.

The invention further relates to the use of the molding material according to the invention for production of reflectors in lights or structural components, for example for automotive engineering.

The invention is hereinbelow elucidated with reference to examples without any intention to limit the invention to these examples.

### EXAMPLES

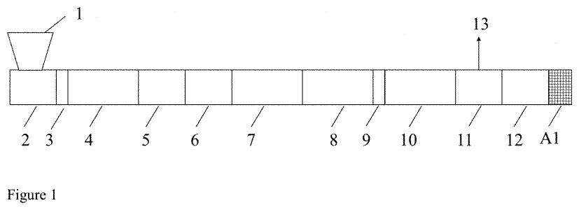

The experiments described in examples 1-3 were performed using a ZE60A UTXi twin-screw extruder from KraussMaffei Berstorff GmbH. The employed twin-screw extruder has a housing internal diameter of 65 mm and an L/D ratio of 43. The schematic construction of the employed extruder is shown in FIG. 1. The twin-screw extruder has a housing consisting of 11 parts in which 2 co-rotating, intermeshing shafts (not shown) are arranged.

In example 1 the metered addition of all constituents of the polycarbonate molding material was performed via the main feed in housing 2 via the pictured feed hopper 1. Located in housing part 11 is the degassing opening 13 which is attached to an extraction apparatus (not shown).

Located in the region of the housings 2 to 5 are conveying zones for a polycarbonate pellet material and a titanium dioxide powder.

Located in the region of the housings 6 and 7 is a plasticizing zone consisting of various two- and three-flight kneading blocks of various widths and also toothed blocks.

Located in the region of the housings 8 to 10 is a mixing zone consisting of kneading elements, toothed blocks and conveying elements.

Located in housing 12 is the pressurization zone followed by a melt filtration (position A1 in FIG. 1) (type: DSC 176 from Maag) and downstream thereof a die plate having 29 holes.

In example 2 the metered addition of the polycarbonate pellet material was performed via the main feed in housing 2 via the pictured feed hopper 1. Metered addition of the titanium dioxide powder was performed via a side feed in housing 8. Located in housing part 11 is the degassing opening 13 which is attached to an extraction apparatus (not shown).

Located in the region of the housings 2 to 5 are conveying zones for the polycarbonate pellet material.

Located in the region of the housings 6 and 7 is a plasticizing zone consisting of various two- and three-flight kneading blocks of various widths and also toothed blocks.

Located in the region of the housings 9 to 10 is a mixing zone consisting of kneading elements, toothed blocks and conveying elements.

Located in housing 12 is the pressurization zone followed by a melt filtration (position A1 in FIG. 1) (type: DSC 176 from Maag) and downstream thereof a die plate having 29 holes.

In example 3 the metered addition of all constituents of the polycarbonate molding material was performed via the main feed in housing 2 via the pictured feed hopper 1. Located in housing part 11 is the degassing opening 13 which is attached to an extraction apparatus (not shown).

Located in the region of the housings 2 to 7 are conveying zones for the polycarbonate pellet material and the titanium dioxide powder.

Located in the region of the housing 8 is a plasticizing zone consisting of various two- and three-flight kneading blocks of various widths and also toothed blocks.

Located in the region of the housing 10 is a mixing zone consisting of toothed blocks.

Located in housing 12 is the pressurization zone followed by a melt filtration (position A1 in FIG. 1) (type: DSC 176 from Maag) and downstream thereof a die plate having 29 holes.

In examples 1 and 3 polycarbonate pellet material and titanium dioxide powder were metered into feed hopper 1 using commercially available gravimetric differential weigh feeders.

In example 2 the polycarbonate pellet material was metered into the feed hopper 1 using a commercially available gravimetric differential weigh feeder. Metered addition of the titanium dioxide powder was performed using a commercially available gravimetric differential weigh feeder via a side feed in housing 8.

In examples 1 to 3 pelletization was carried out in the form of strand pelletization after water bath cooling.

In examples 1 to 3 measurement of the melt temperature was carried out by insertion of a thermocouple into the issuing melt of the central melt strand directly in front of the die.

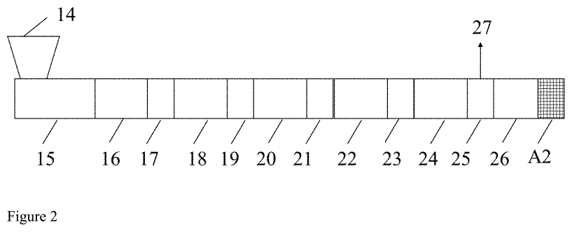

The experiment (according to the invention) described in example 4 was performed using a Ringextruder RE 3XP multi-screw extruder from Extricom GmbH. The employed multi-screw extruder has 12 shafts having a screw outer diameter of 30 mm in each case, a DA/DI ratio of 1.55 and an L/D ratio of 39. The schematic construction of the employed extruder is shown in FIG. 2.

The multi-screw extruder has a housing consisting of 12 parts in which 12 co-rotating, intermeshing shafts (not shown) are arranged.

The metered addition of all constituents of the polycarbonate molding material was performed via the main feed in housing 15 in the pictured feed hopper 14. Located in housing part 25 is the degassing opening 27 which is attached to an extraction apparatus (not shown).

Located in the region of the housings 15 to 19 are conveying zones for the polycarbonate pellet material and the titanium dioxide powder.

Located in the region of the housing 20 is a plasticizing zone consisting of various two-flight kneading blocks of various widths and also toothed mixing elements.

Located in the region of the housings 22 to 24 is a mixing zone consisting of various conveying and mixing elements.

Located in housing 26 is the pressurization zone followed by a melt filtration (position A2 in FIG. 2) (type K-SWE-121 from Kreyenborg) and downstream thereof a die plate having 24 holes.

In example 4 polycarbonate pellet material and titanium dioxide powder were metered into the feed hopper 14 using commercially available gravimetric differential weigh feeders.

Pelletization was carried out in the form of strand pelletization after water bath cooling.

Measurement of the melt temperature was carried out by insertion of a thermocouple into the issuing melt in one of the two central melt strands directly in front of the die.

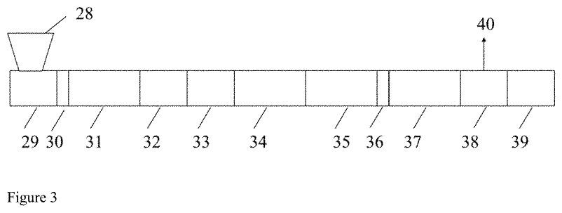

The experiment described in example 5 was performed using a ZE60A UTXi twin-screw extruder from KraussMaffei Berstorff GmbH. The employed twin-screw extruder has a housing internal diameter of 65 mm and an L/D ratio of 43. The schematic construction of the employed extruder is shown in FIG. 3. The twin-screw extruder has a housing consisting of 11 parts in which 2 co-rotating, intermeshing shafts (not shown) are arranged.

In example 5 the metered addition of all constituents of the polycarbonate molding material was performed via the main feed in housing 29 via the pictured feed hopper 28. Located in housing part 38 is the degassing opening 40 which is attached to an extraction apparatus (not shown).

Located in the region of the housings 30 to 32 are conveying zones for the polycarbonate pellet material and the titanium dioxide powder.

Located in the region of the housing 33 is a plasticizing zone consisting of various two- and three-flight kneading blocks of various widths and also toothed blocks.

Located in the region of the housings 35 to 37 is a mixing zone consisting of kneading elements, toothed blocks and conveying elements.

Located in housing 39 is the pressurization zone and downstream thereof a die plate having 29 holes.

In example 5 polycarbonate pellet material and titanium dioxide powder were metered into the feed hopper 28 using commercially available gravimetric differential weigh feeders.

Pelletization was carried out in the form of strand pelletization after water bath cooling.

In example 5 measurement of the melt temperature was carried out by insertion of a thermocouple into the issuing melt of the central melt strand directly in front of the die.

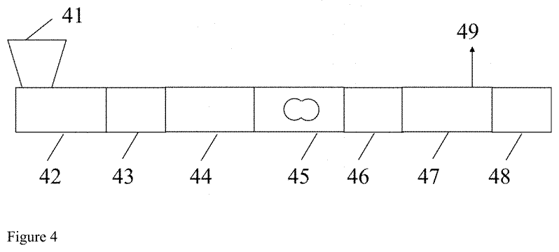

The experiments (according to the invention) described in examples 6 to 8 were performed using a Ringextruder RE 1XPV multi-screw extruder from Extricom GmbH. The employed multi-screw extruder has 12 shafts having a screw outer diameter of 18.7 mm in each case, a DA/DI ratio of 1.74 and an L/D ratio of 35. The schematic construction of the employed extruder is shown in FIG. 4. The multi-screw extruder has a housing consisting of 7 parts in which 12 co-rotating, intermeshing shafts (not shown) are arranged.

In examples 6 to 8 the metered addition of the polycarbonate pellet material was performed via the main feed in housing 42 via the pictured feed hopper 41. Metered addition of the titanium dioxide powder was performed via a side feed in housing 45. Located in housing part 47 is the degassing opening 49 which is attached to an extraction apparatus (not shown).

Located in the region of the housing 43 is a conveying zone for the polycarbonate pellet material.

Located in the region of the housing 44 is a plasticizing zone consisting of various two-flight kneading blocks of various widths.

Located in the region of the housings 45 to 47 are mixing zones consisting of kneading elements, toothed blocks and conveying elements.

Located in housing 48 is the pressurization zone and downstream thereof a die plate having 7 holes.

In examples 6 to 8 the polycarbonate pellet material was metered into the feed hopper 41 using a commercially available gravimetric differential weigh feeder. Metered addition of the titanium dioxide powder was performed using a commercially available gravimetric differential weigh feeder via a side feed in housing 45.

Pelletization was carried out in the form of strand pelletization after water bath cooling.

Measurement of the melt temperature was carried out by insertion of a thermocouple into the issuing melt in the central melt strand directly in front of the die.

The experiments described in examples 9 to 11 were performed using an Evolum 32HT twin-screw extruder from Clextral. The employed twin-screw extruder has a housing internal diameter of 32 mm and an L/D ratio of 36. The schematic construction of the employed extruder is shown in FIG. 13. The twin-screw extruder has a housing consisting of 9 parts in which 2 co-rotating, intermeshing shafts (not shown) are arranged.

In example 9 metered addition of the talc powder was performed via a side feed (not shown) into the housing 55. The remaining constituents of the polycarbonate molding material were supplied via the main feed in housing 51 via the pictured feed hopper 50. Located in housing part 58 is the degassing opening 60 which is attached to an extraction apparatus (not shown).

Located in the region of the housings 52 and 53 is a conveying zone for the polycarbonate pellet material and the powder premix.

Located in the region of the housing 54 is a plasticizing zone consisting of various two- and three-flight kneading blocks of various widths and also toothed blocks.

Located in the region of the housings 56 to 58 is a mixing zone consisting of kneading elements, toothed mixing elements and conveying elements.

Located in housing 59 is the pressurization zone and downstream thereof a die plate having 6 holes.

In example 9 polycarbonate pellet material and the powder premix were metered into the feed hopper 50 via commercially available gravimetric differential weigh feeders and the talc powder was metered into the feed hopper of the side feed (not shown) using commercially available gravimetric differential weigh feeders.

Pelletization was carried out in the form of strand pelletization after water bath cooling.

In example 9 measurement of the melt temperature was carried out by insertion of a thermocouple into the issuing melt of one of the two central melt strands directly in front of the die.

In examples 10 and 11 the metered addition of half of the talc powder was performed via a side feed (not shown) into the housing 55. The remaining constituents of the polycarbonate molding material including the remaining half of the talc powder were supplied via the main feed in housing 51 via the pictured feed hopper 50. Located in housing part 58 is the degassing opening 60 which is attached to an extraction apparatus (not shown).

Located in the region of the housings 52 and 53 is a conveying zone for the polycarbonate pellet material, the powder premix and the talc powder.

Located in the region of the housing 54 is a plasticizing zone consisting of various two- and three-flight kneading blocks of various widths and also toothed blocks.

Located in the region of the housings 56 to 58 is a mixing zone consisting of kneading elements, toothed mixing elements and conveying elements.

Located in housing 59 is the pressurization zone and downstream thereof a die plate having 6 holes.

In examples 10 and 11 polycarbonate pellet material, the powder premix and one half of the talc powder were metered into the feed hopper 50 via commercially available gravimetric differential weigh feeders and the other half of the talc powder was metered into the feed hopper of the side feed (not shown) via commercially available gravimetric differential weigh feeders.

Pelletization was carried out in the form of strand pelletization after water bath cooling.

In examples 10 and 11 measurement of the melt temperature was carried out by insertion of a thermocouple into the issuing melt of one of the two central melt strands directly in front of the die.

The experiments (according to the invention) described in examples 12 to 14 were performed using a Ringextruder RE 1XPV multi-screw extruder from Extricom GmbH. The employed multi-screw extruder has 12 shafts having a screw outer diameter of 18.7 mm in each case, a DA/DI ratio of 1.74 and an L/D ratio of 35. The schematic construction of the employed extruder is shown in FIG. 4. The multi-screw extruder has a housing consisting of 7 parts in which 12 co-rotating, intermeshing shafts (not shown) are arranged.

In examples 12 to 14 the metered addition of the polycarbonate pellet material and the powder premix was performed via the main feed in housing 42 via the pictured feed hopper 41. In example 12 the metered addition of the talc powder was performed via a side feed in housing 45. In examples 13 and 14 metered addition of the talc powder was performed via two side feeds in housing 45, wherein the side feeds in housing 45 are arranged opposite one another. In examples 13 and 14 each side feed was used to perform metered addition of half of the talc powder.

Located in housing part 47 is the degassing opening 49 which is attached to an extraction apparatus (not shown).

Located in the region of the housing 43 is a conveying zone for the polycarbonate pellet material and the powder premix.

Located in the region of the housing 44 is a plasticizing zone consisting of various two-flight kneading blocks of various widths.

Located in the region of the housings 45 to 47 are mixing zones consisting of kneading elements, toothed blocks and conveying elements.

Located in housing 48 is the pressurization zone and downstream thereof a die plate having 7 holes.

In examples 12 to 14 the polycarbonate pellet material and the powder premix were metered into the feed hopper 41 using a commercially available gravimetric differential weigh feeder. In example 12 metered addition of the talc powder was performed using a commercially available gravimetric differential weigh feeder via a side feed in housing 45 and in examples 13 and 14 performed using two commercially available gravimetric differential weigh feeders via a side feed in housing 45.

Pelletization was carried out in the form of strand pelletization after water bath cooling.

Measurement of the melt temperature was carried out by insertion of a thermocouple into the issuing melt in the central melt strand directly in front of the die.

To evaluate the dispersion efficiency of the titanium dioxide powder in examples 1 to 4 the pressure upstream of the melt sieve was measured using an incorporated pressure sensor in each case at commencement of the experiment, after achieving a constant torque, and after 60 minutes.

The pressure increase as shown in table 1 was calculated as follows: Pressure increase [in bar/min]=(pressure after 60 minutes minus pressure at commencement of experiment) divided by 60 min.

The polycarbonate composition produced in examples 5 to 14 was then processed by injection molding into test specimens having a length and width of 60 mm in each case and a thickness of 2 mm.

The injection molding was carried out under the following processing conditions characteristic for polycarbonates: Melt temperature: 310° C., mold temperature: 90° C. Before processing by injection molding the pellets of the polycarbonate molding material were pre-dried at 110° C. for 4 hours.

The testing of puncture force and deformation was carried out on the injection-molded test specimens from examples 5 to 14 according to DIN EN ISO 6603-2:2000 at 23° C. In each case 10 test specimens were tested and the arithmetic mean was determined from these results.

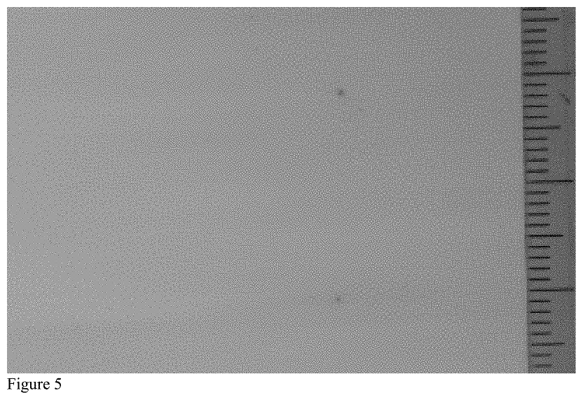

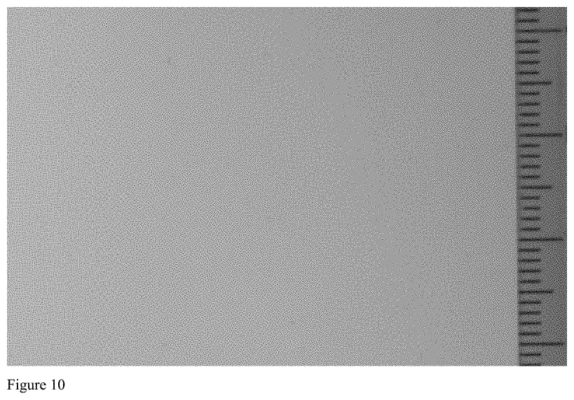

For examples 1 to 8 the dispersion efficiency of the titanium dioxide powder was determined by visual evaluation of extruded films. To this end the produced pellet materials of the polycarbonate molding material were employed to produce films of 150 μm in thickness using a film extrusion line essentially consisting of a single-screw extruder with a downstream roller apparatus. These films were then photographed with a camera on a commercially available light table in transmitted-light mode with superimposed scale. The photographs (see FIGS. 5 to 12) were then visually assessed and categorized into performance classes 1 (excellent) to 6 (poor) (see table 2). The following applies to all FIGS. 5 to 12: Scale: 1 division corresponds to 1 mm; incompletely dispersed titanium dioxide particles are apparent as dark areas in the image.

Testing of notched impact strength for examples 9 to 14 was performed by means of an impact flexural test according to DIN EN ISO 180/1A at 23° C. on injection-molded test specimens having dimensions of 80×10×3 mm. In each case 10 test specimens were tested and the arithmetic mean was determined from these results.

In examples 1 to 6 the molding material passed into the respective extruder consists of a mixture of:
85% by weight of pellets of a linear polycarbonate based on bisphenol A having a relative viscosity ηᵣₑₗ=1.32 (measured in CH₂Cl₂ as solvent at 25° C. and at a concentration of 0.5 g/100 ml) and
15% by weight of a titanium dioxide powder (KRONOS 2230 from Kronos Titan).

In example 7 the molding material passed into the extruder consists of a mixture of:
80% by weight of a linear polycarbonate based on bisphenol A having a relative viscosity ηᵣₑₗ=1.32 (measured in CH₂Cl₂ as solvent at 25° C. and at a concentration of 0.5 g/100 ml) and
20% by weight of a titanium dioxide powder (KRONOS 2230 from Kronos Titan).

In example 8 the molding material passed into the extruder consists of a mixture of:
70% by weight of a linear polycarbonate based on bisphenol A having a relative viscosity ηᵣₑₗ=1.32 (measured in CH₂Cl₂ as solvent at 25° C. and at a concentration of 0.5 g/100 ml) and
30% by weight of a titanium dioxide powder (KRONOS 2230 from Kronos Titan).

In examples 9 to 12 the molding material passed into the respective extruder consists of a mixture of:
80% by weight of a linear polycarbonate based on bisphenol A having a relative viscosity ηᵣₑₗ=1.293 (measured in CH₂Cl₂ as solvent at 25° C. and at a concentration of 0.5 g/100 ml),
15% by weight of a talc powder (HTP Ultra 5C from Imi Fabi) and
5% by weight of a powder mixture consisting of 80% by weight of a linear polycarbonate based on bisphenol A having a relative viscosity ηᵣₑₗ=1.32 (measured in CH₂Cl₂ as solvent at 25° C. and at a concentration of 0.5 g/100 ml) and 20% by weight of a maleic anhydride-grafted polyolefin copolymer (Hi-WAX 1105A from Mitsui Chemicals).

In examples 10 and 13 the molding material passed into the respective extruder consists of a mixture of:
75% by weight of a linear polycarbonate based on bisphenol A having a relative viscosity ηᵣₑₗ=1.293 (measured in CH₂Cl₂ as solvent at 25° C. and at a concentration of 0.5 g/100 ml),
20% by weight of a talc powder (HTP Ultra 5C from Imi Fabi) and
5% by weight of a powder mixture consisting of 80% by weight of a linear polycarbonate based on bisphenol A having a relative viscosity ηᵣₑₗ=1.32 (measured in CH₂Cl₂ as solvent at 25° C. and at a concentration of 0.5 g/100 ml) and 20% by weight of a maleic anhydride-grafted polyolefin copolymer (Hi-WAX 1105A from Mitsui Chemicals).

In examples 11 and 14 the molding material passed into the respective extruder consists of a mixture of:
65% by weight of a linear polycarbonate based on bisphenol A having a relative viscosity ηᵣₑₗ=1.293 (measured in CH₂Cl₂ as solvent at 25° C. and at a concentration of 0.5 g/100 ml),
30% by weight of a talc powder (HTP Ultra 5C from Imi Fabi) and
5% by weight of a powder mixture consisting of 70% by weight of a linear polycarbonate based on bisphenol A having a relative viscosity ηᵣₑₗ=1.32 (measured in CH₂Cl₂ as solvent at 25° C. and at a concentration of 0.5 g/100 ml) and 30% by weight of a maleic anhydride-grafted polyolefin copolymer (Hi-WAX 1105A from Mitsui Chemicals).

### Comparative Examples 1 to 3

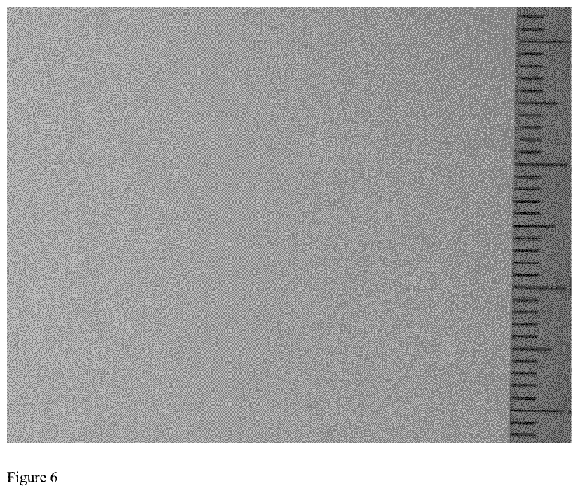

Comparative Examples 1 and 3 differ in the rotational speed of the extruder. While the extruder speed is 300 rpm in example 1 it is twice as high, at identical throughput of 580 kg/h, in example 3. The increase in rotational speed does result in markedly improved dispersion as is apparent from the much lower pressure increase upstream of the melt sieve (see table 1) and the reduced number of undispersed titanium dioxide particles (see FIG. 5 (example 1) compared to FIG. 6 (example 2)). However at the higher rotational speed in example 3 the melt temperature simultaneously increases by 34° C., thus promoting polymer decomposition in a manner known to those skilled in the art.

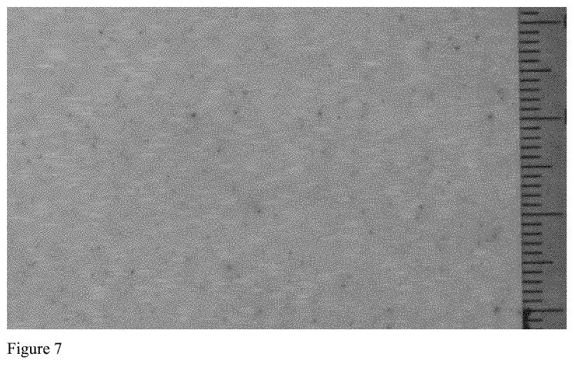

Comparative examples 1 and 2 differ only in the metered addition site of the titanium dioxide powder. While in example 1 the titanium dioxide powder was added into the feed hopper 1, in example 2 addition was performed after the melting via a side feed in housing 8, into the polycarbonate melt. As is apparent from table 1 the addition of the titanium dioxide powder after the melting in example 2 results in a markedly greater pressure increase upstream of the melt sieve which is an indication of poorer dispersion, and this is also confirmed in FIG. 7 which shows a large number of very poorly dispersed titanium dioxide particles. In comparison, the number of large titanium dioxide particles in FIG. 5 (example 1) is markedly lower.

### Example 4 (According to the Invention)

It was the objective of example 4 according to the invention to achieve a titanium dioxide dispersion at least comparable with comparative example 3 but at a markedly lower melt temperature. It therefore employed a setup and a throughput and a rotational speed of the process according to the invention which resulted in a comparable pressure increase upstream of the melt sieve as in comparative example 3. Both in examples 1 and 3 and in example 4 the titanium dioxide was in each case added to the extruder via the feed hopper 1 and 14, respectively.

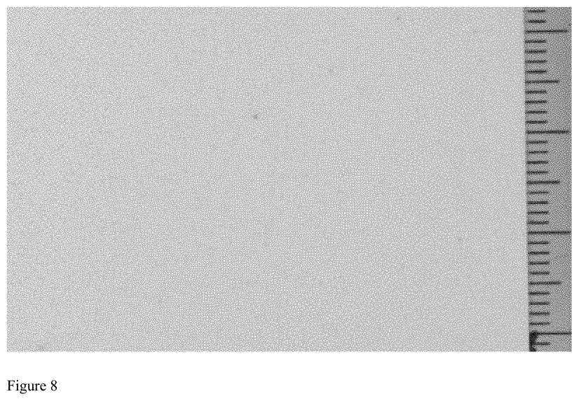

Comparison of example 4 according to the invention with examples 1 and 3 not according to the invention shows that the process according to the invention achieved markedly better dispersion of the titanium dioxide particles while simultaneously making it possible to attain a lower melt temperature. This is apparent from the fact that the pressure increase in example 4 is just as high as that in example 3 but the melt temperature is 35° C. lower (see table 1). It is also apparent in FIG. 8 that the number of poorly dispersed titanium dioxide particles is comparable to example 3 (FIG. 6) but lower than in example 1 (FIG. 5).

### Comparative Example 5

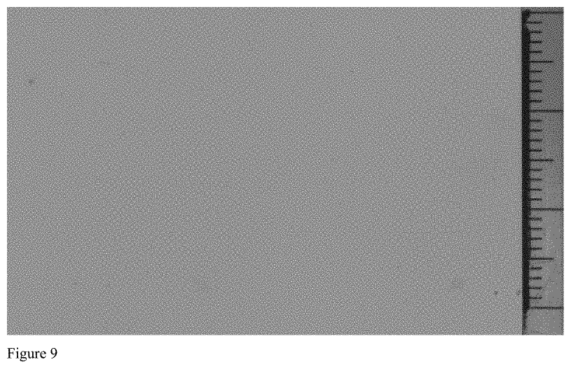

In comparative example 5 the titanium dioxide powder was added to a co-rotating twin-screw extruder via the feed hopper 28. The dispersion efficiency of the titanium dioxide was determined by visual determination of the size and number of incompletely dispersed titanium dioxide particles in a film produced as described above (see FIG. 9). In addition, the multi-axial mechanical properties were determined by means of an above-described puncture test according to DIN EN ISO 6603-2:2000 at 23° C.

### Example 6 (According to the Invention)

In example 6 according to the invention titanium dioxide powder was added in housing 45 after the melting of the polycarbonate. This process mode had the result in comparative example 2 that the dispersion of the titanium dioxide particles was substantially poorer than for addition into the first extruder housing (see pressure increase in table 1 and resulting particle sizes in FIG. 7).

The puncture test on specimens from example 6 according to the invention shows a markedly higher mathematical product of maximum deformation and maximum force than comparative example 5 (see table 1). The visual evaluation of the film also reveals better dispersion of the titanium dioxide particles in example 6 according to the invention compared to example 5. This demonstrates that the process according to the invention results in improved dispersion of the titanium dioxide particles and better mechanical properties even in the case of sub-optimal addition of the titanium dioxide powder, i.e. after the melting of the polycarbonate.

Example 6 according to the invention simultaneously achieves a melt temperature 44° C. lower than in comparative example 5 (see table 1).

### Example 7 (According to the Invention)

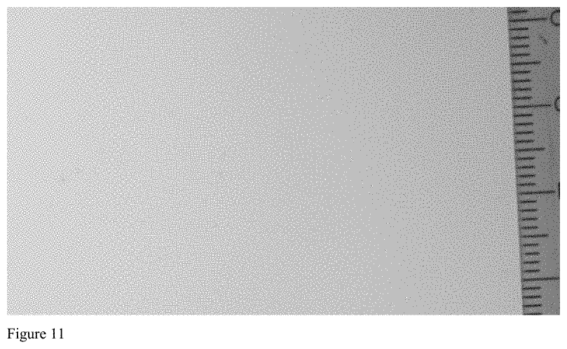

In example 7, 20% by weight of titanium dioxide powder was added in housing 45 after the melting of the polycarbonate. Despite the sub-optimal addition site of the titanium dioxide compared to comparative example 5 and the simultaneously greater amount of titanium dioxide, which is well known to result in embrittlement of the polycarbonate molding material, only a slightly lower mathematical product of maximum deformation and maximum force than in the comparative example was measured (see table 1). Visual assessment of the titanium particle dispersion using the films shows that the films made of the polycarbonate molding material according to the invention from example 7 (see FIG. 11) exhibit better titanium dioxide dispersion than the films made of the polycarbonate molding material of comparative example 5 (see FIG. 9). Even at the higher titanium dioxide proportions the melt temperature is 42° C. lower than in comparative example 5 (see table 1).

### Example 8 (According to the Invention)

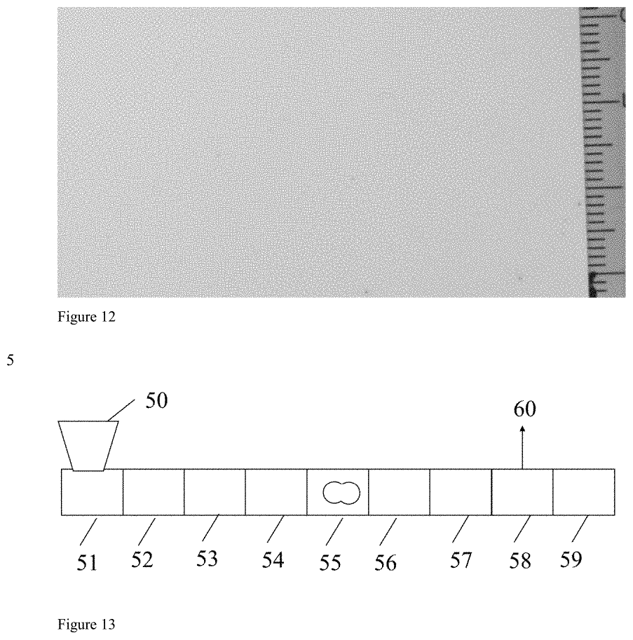

In example 8, 30% by weight of titanium dioxide powder was added in housing 45 after the melting of the polycarbonate. Despite the sub-optimal addition site of the titanium dioxide compared to comparative example 5 and the simultaneously greater amount of titanium dioxide, which is well known to result in embrittlement of the polycarbonate molding material, only a slight reduction in the mathematical product of maximum deformation and maximum force relative to what is familiar from comparable products (see table 1) was found. Visual assessment of the titanium particle dispersion using the films shows that the films made of the polycarbonate molding material according to the invention from example 8 (see FIG. 12) exhibit approximately equally good titanium dioxide dispersion compared to the films made of the polycarbonate molding material of comparative example 5 (see FIG. 9). Even at double the titanium dioxide proportion the melt temperature is 41° C. lower than in comparative example 5 (see table 1).

### Comparative Example 9

In comparative example 9 the talc powder was added to a co-rotating twin-screw extruder via a side feed in housing 55. Dispersion efficiency was determined on the basis of notched impact strength using an above-described notched impact flexural strength test according to DIN EN ISO 180/1A at 23° C. and on the basis of multiaxial mechanical properties using an above-described puncture test according to DIN EN ISO 6603-2:2000 at 23° C.

### Comparative Examples 10 and 11

In comparative examples 10 and 11 in each case one half of the talc powder was added to a co-rotating twin-screw extruder via the feed hopper 50 and the other half of the talc powder via a side feed in housing 55. Comparative examples 10 and 11 differ in the proportion of talc powder in the formulation. In example 10, 20% by weight of talc, and in example 11, 30% by weight of talc, was added to the co-rotating twin-screw extruder. Dispersion efficiency was determined on the basis of notched impact strength using an above-described notched impact flexural strength test according to DIN EN ISO 180/1A at 23° C. and on the basis of multiaxial mechanical properties using an above-described puncture test according to DIN EN ISO 6603-2:2000 at 23° C.

### Example 12 (According to the Invention)

In example 12, 15% by weight of talc powder was added to the ring extruder via a side feed in housing 45 after the melting of the polycarbonate. Compared to comparative example 9 markedly better mechanical properties were achieved despite a lower energy input discernible from the 5° C. lower melt temperature of the example according to the invention (see table 1). The mathematical product of maximum deformation and maximum force was 7.4% higher in example 12 according to the invention than in comparative example 9 and notched impact strength was even 113% higher (see table 1).

### Example 13 (According to the Invention)

In example 13, 10% by weight of talc powder was added to the ring extruder via feed hopper 41 and a further 10% by weight via a side feed in housing 45 after the melting of the polycarbonate. Compared to comparative example 10 markedly better mechanical properties were achieved despite a lower energy input discernible from the 8° C. lower melt temperature of the example according to the invention (see table 1). The mathematical product of maximum deformation and maximum force was 23% higher in example 13 according to the invention than in comparative example 10 and notched impact strength was even 197% higher (see table 1).

### Example 14 (According to the Invention)

In example 14, 15% by weight of talc powder was added to the ring extruder via feed hopper 41 and a further 15% by weight via a side feed in housing 45 after the melting of the polycarbonate. Compared to comparative example 11 markedly better mechanical properties were achieved despite a lower energy input discernible from the 38° C. lower melt temperature of the example according to the invention (see table 1). The mathematical product of maximum deformation and maximum force was 1116% higher in example 14 according to the invention than in comparative example 10 and notched impact strength was even 336% higher (see table 1).

TABLE 1

| | | | | | | | | | | Puncture test DIN EN | | | | | |
|---|---|---|---|---|---|---|---|---|---|---|---|---|---|---|---|
| | | | | | | | | | | ISO 6603-2:2000 | | | | | |
| | | | | | | | | | | at 23° C. | | | Disper- | | |
| | | | | | | | | | | | | Mathe- | sion | | |
| | | Con- | | | | | | | | | | matical | perfor- | | |
| | | tent of | | | | | | | | | | product | mance | | |
| | | rein- | | | | | | | | | | of max. | (as per | Ac- | |
| | | forc- | | | | | Through- | Pressure | | | | force | classi- | com- | Notched |
| | | ing | | Rota- | | | put | increase | Melt | | Max | and max. | fica- | pany- | impact |
| | | filler | Through- | tional | Mesh | Sieve | sieve | upstream | temper- | Max | defor- | defor- | tion in | ing | strength |
| | | % by | put | speed | width | area | area kg/ | of sieve | ature | force | mation | mation | table | fig- | ISO |
| No. | | [symbol] | kg/h | rpm | μm | cm² | (h * cm²⁾ | bar/min | ° C. | N | mm | N * mm | 2) | ure | 180/1A |
| 1 | Compar- | 15 | 580 | 300 | 125 | 430 | 1.35 | 0.2 | 368 | | | | 5 | 5 | |
| | ative | | | | | | | | | | | | | | |
| 2 | Compar- | 15 | 580 | 300 | 125 | 430 | 1.35 | 0.41 | 368 | | | | 6 | 7 | |
| | ative | | | | | | | | | | | | | | |
| 3 | Compar- | 15 | 580 | 600 | 125 | 430 | 1.35 | 0.04 | 402 | | | | 4 | 6 | |
| | ative | | | | | | | | | | | | | | |
| 4 | According | 15 | 300 | 500 | 120 | 424 | 0.71 | 0.03 | 367 | | | | 3 | 8 | |
| | to the | | | | | | | | | | | | | | |
| | [symbol] | | | | | | | | | | | | | | |
| 5 | Compar- | 15 | 690 | 600 | | | | | 386 | 4939 | 16.7 | 82481.3 | 4 | 9 | |
| | ative | | | | | | | | | | | | | | |
| 6 | According | 15 | 80 | 600 | | | | | 342 | 5244 | 16.3 | 85477.2 | 2 | 10 | |
| | to the | | | | | | | | | | | | | | |
| | [symbol] | | | | | | | | | | | | | | |
| 7 | According | 20 | 80 | 600 | | | | | 344 | 5177 | 15.7 | 81278.9 | 3 | 11 | |
| | to the | | | | | | | | | | | | | | |
| | [symbol] | | | | | | | | | | | | | | |
| 8 | According | 30 | 80 | 600 | | | | | 345 | 4902 | 14.1 | 69118.2 | 3 | 12 | |
| | to the | | | | | | | | | | | | | | |
| | [symbol] | | | | | | | | | | | | | | |
| 9 | Compar- | 15 | 50 | 300 | | | | | 314 | 4557 | 15.5 | 70633.5 | | | 25.4 |
| | ative | | | | | | | | | | | | | | |
| 10 | Compar- | 20 | 50 | 300 | | | | | 314 | 4461 | 15.2 | 67807.2 | | | 21.5 |
| | ative | | | | | | | | | | | | | | |
| 11 | Compar- | 30 | 50 | 300 | | | | | 328 | 584 | 5.1 | 2978.4 | | | 4.2 |
| | ative | | | | | | | | | | | | | | |
| 12 | According | 15 | 210 | 793 | | | | | 309 | 4599 | 16.5 | 75883.5 | | | 54.1 |
| | to the | | | | | | | | | | | | | | |
| | [symbol] | | | | | | | | | | | | | | |
| 13 | According | 20 | 100 | 400 | | | | | 306 | 4770 | 17.5 | 83475 | | | 63.8 |
| | to the | | | | | | | | | | | | | | |
| | [symbol] | | | | | | | | | | | | | | |
| 14 | According | 30 | 150 | 400 | | | | | 290 | 3177 | 11.4 | 36217.8 | | | 18.3 |
| | to the | | | | | | | | | | | | | | |
| | [symbol] | | | | | | | | | | | | | | |

[symbol]

indicates data missing or illegible when filed

TABLE 2

| Dispersion | | | | |
|---|---|---|---|---|
| efficiency | | | | |
| classification | | Agglomerates | | |
| Classes | | Large | Medium | Small |
| 1 | excellent | none | none | none |
| 2 | good | none | none | isolated |
| 3 | satisfactory | none | isolated | some |
| 4 | adequate | isolated | isolated | some |
| 5 | reasonable | isolated | some | some |
| 6 | poor | some | some | some |

1. A process for producing a molding material containing a polycarbonate and a reinforcing filler, wherein the molding material is compounded in a ring extruder.

2. The process as claimed in claim 1, wherein the molding material contains the following constituents:
97% to 50% by weight of polycarbonate,
3% to 50% by weight of reinforcing filler,
0% to 37% by weight of other constituents,
wherein the constituents sum to 100% by weight.

3. The process as claimed in claim 1, wherein the reinforcing filler is one or more members selected from the group consisting of titanium dioxide (TiO₂), talc (Mg₃Si₄O₁₀(OH)₂), dolomite (CaMg[CO₃]₂), kaolinite (Al₄[(OH)₈|Si₄O₁₀]) and wollastonite (Ca₃[Si₃O₉]).

4. The process as claimed in claim 1, wherein the molding material contains 10% to 35% by weight of reinforcing filler.

5. The process as claimed in claim 4, wherein the reinforcing filler is titanium dioxide (TiO₂).

6. The process as claimed in claim 1, wherein the molding material contains 10% to 40% by weight of reinforcing filler.

7. The process as claimed in claim 6, wherein the reinforcing filler is talc (Mg₃Si₄O₁₀(OH)₂).

8. The process as claimed in claim 1, wherein the molding material contains 0% to 20% by weight of other constituents, wherein the constituents sum to 100% by weight.

9. The process as claimed in claim 1, wherein the process comprises the following steps:
(1) adding polycarbonate, reinforcing filler and optionally other constituents to a ring extruder;
(2) compounding polycarbonate and reinforcing filler and optionally other constituents with the ring extruder.

10. The process as claimed in claim 1, wherein the addition of the reinforcing filler is carried out either before the melting of the polycarbonate or after the melting of the polycarbonate.

11. The process as claimed in claim 1, wherein the ring extruder has an L/D ratio of 28 to 45.

12. The process as claimed in claim 1, wherein the ring extruder has a DA/DI ratio of 1.5 to 1.8.

13. The process as claimed in claim 1, wherein the ring extruder has a torque density of 2 to 10 Nm/cm³.

14. A molding material produced by a process as claimed in claim 1.

15. The use of a molding material according to claim 14 for producing reflectors in lights or structural components.

16. The process as claimed in claim 1, wherein the reinforcing filler is one or more members selected from the group consisting of titanium dioxide (TiO₂) and talc (Mg₃Si₄O₁₀(OH)₂).

17. The process as claimed in claim 1, wherein the molding material contains 12% to 32% by weight of reinforcing filler.

18. The process as claimed in claim 1, wherein the molding material contains 17% to 30% by weight of reinforcing filler.

19. The process as claimed in claim 1, wherein the molding material contains 0% to 10% by weight of other constituents, wherein the constituents sum to 100% by weight.

20. The process as claimed in claim 1, wherein the ring extruder has an L/D ratio of 33 to 42.
